(19) United States
(12) Patent Application Publication
(10) Pub. No.: US 2014/0198836 A1
(43) Pub. Date: Jul. 17, 2014

(54) METHOD AND APPARATUS FOR WIDEBAND SPECTRUM SENSING USING COMPRESSIVE SENSING

(71) Applicant: Electronics and Telecommunications Research Institute, Daejeon (KR)

(72) Inventors: Sun Min LIM, Daejeon (KR); Hoi Yoon JUNG, Daejeon (KR); Sang Won KIM, Daejeon (KR); Byung Jang JEONG, Daejeon (KR)

(73) Assignee: Electronics and Telecommunications Research Institute, Daejeon (KR)

(21) Appl. No.: 13/920,516

(22) Filed: Jun. 18, 2013

(30) Foreign Application Priority Data
Jan. 17, 2013 (KR) 10-2013-0005216

(51) Int. Cl. H04B 1/10

(52) U.S. Cl. CPC H04B 1/1036
USPC 375/240

(57) ABSTRACT

Disclosed is a method for wideband spectrum sensing using compressive sensing, the method including: acquiring a sampling signal by applying a modulated wideband converter (MWC) to a received signal; and acquiring a restoration signal corresponding to the received signal by using a compressive sensing restoration algorithm from the sampling signal, and a mixing signal multiplied by the received signal at the time of applying the MWC, as a signal transformed from a first mixing signal having a periodic waveform, includes a second mixing signal to remove a partial frequency area from the received signal through the application of the MWC.

### CROSS-REFERENCE TO RELATED APPLICATIONS

This application claims priority to and the benefit of Korean Patent Application No. 10-2013-0005216 filed in the Korean Intellectual Property Office on Jan. 17, 2013, the entire contents of which are incorporated herein by reference.

### TECHNICAL FIELD

The present invention relates to a method and an apparatus for wideband spectrum sensing, and more particularly, to a method and an apparatus for wideband spectrum sensing using compressive sensing.

### BACKGROUND

In a recognition wireless system, a database (DB) having channel use information is used or a channel use status is determined through spectrum sensing in order to find an empty channel. Since advance information is not provided in the case of the spectrum sensing, communication quality can be assured by determining a channel occupation status and channel quality through scanning all channels to be sensed. Since only channel use information of a registered user can be known in the case of using the database, the communication quality can deteriorate due to other interference signals or noise, and as a result, verification of the channel quality is additionally required.

In general, an analog digital converter (ADC) and a signal processing module having a very high specification are required to sense a wideband spectrum, and as a result, hardware cost and a calculation amount are increased. In an existing wideband spectrum sensing technique, when an auto gain control (AGC) is performed in accordance a high signal level, in order to solve a problem in which a signal having a low reception level is not detected, two steps of rapidly detecting a signal having a high level through wideband reception and detecting the signal having the low level, which is not detected at that time, by controlling the AGC through narrowband reception are performed. Therefore, since a wideband receiver and a narrowband receiver need to be provided for the wideband spectrum sensing technique, there is a problem in which the hardware cost is increased and complexity is high.

### SUMMARY

The present invention has been made in an effort to provide a method and an apparatus for wideband spectrum sensing which are more efficient, and in which hardware cost and a calculation amount are reduced by using a compressive sensing technique.

An exemplary embodiment of the present invention provides a method for wideband spectrum sensing using compressive sensing, the method including: acquiring a sampling signal by applying a modulated wideband converter (MWC) to a received signal; and acquiring a restoration signal corresponding to the received signal by using a compressive sensing restoration algorithm from the sampling signal, and a mixing signal multiplied by the received signal at the time of applying the MWC is a signal transformed from a first mixing signal having a periodic waveform and includes a second mixing signal to remove a partial frequency area from the received signal through the application of the MWC.

The second mixing signal may be acquired by removing a frequency component corresponding to the partial frequency area from the first mixing signal.

The acquiring of the sampling signal and the acquiring of the restoration signal may be repeatedly performed.

The method may further include: measuring the level of the sampling signal; and performing an auto gain control (AGC) of the received signal in accordance with the level measurement result.

The method may further include: detecting an occupation channel of the received signal from the restoration signal; and generating the second mixing signal to remove the frequency area of the detected occupation channel from the received signal through the application of the MWC, from the first mixing signal.

The generating of the second mixing signal may be achieved by changing Fourier coefficients corresponding to the frequency area of the detected occupation channel in the first mixing signal.

The method may further include: acquiring occupation channel information of the received signal from a database; and generating the second mixing signal to remove a frequency area of the acquired occupation channel information from the received signal through the application of the MWC, from the first mixing signal.

The generating of the second mixing signal may be achieved by changing Fourier coefficients corresponding to the frequency area of the acquired occupation channel information in the first mixing signal.

Another exemplary embodiment of the present invention provides an apparatus for wideband spectrum sensing using compressive sensing, the apparatus including: a modulated wideband converter (MWC) multiplying a mixing signal by a received signal and acquiring a sampling signal therefrom; and a signal restoring unit acquiring a restoration signal corresponding to the received signal by using a compressive sensing restoration algorithm from the sampling signal, and the mixing signal is a signal transformed from a first mixing signal having a periodic waveform and includes a second mixing signal to remove a partial frequency area from the received signal through the MWC.

The second mixing signal may be acquired by removing a frequency component corresponding to the partial frequency area from the first mixing signal.

The MWC and the signal restoring unit may repeatedly acquire the sampling signal and the restoration signal, respectively.

The apparatus may further include: a level measuring unit measuring the level of the sampling signal; and an AGC unit performing an auto gain control (AGC) of the received signal in accordance with the level measurement result.

The apparatus may further include: an occupation channel detecting unit detecting an occupation channel of the received signal from the restoration signal; and a waveform generating unit generating the second mixing signal to remove the frequency area of the detected occupation channel from the received signal through the MWC, from the first mixing signal.

The waveform generating unit may generate the second mixing signal by changing Fourier coefficients corresponding to the frequency area of the detected occupation channel in the first mixing signal.

The apparatus may further include: an occupation channel acquiring unit acquiring occupation channel information of the received signal from a database; and a waveform generating unit generating the second mixing signal to remove a frequency area of the acquired occupation channel information from the received signal through the MWC, from the first mixing signal.

The waveform generating unit may generate the second mixing signal by changing Fourier coefficients corresponding to the frequency area of the acquired occupation channel information in the first mixing signal.

According to the exemplary embodiments of the present invention, a compressive sensing technique is used in wideband spectrum sensing and a modified mixing signal to remove a partial frequency area from a received signal is used as a signal in which a mixing signal having a periodic waveform is modified at the time of applying an MWC, thereby reducing hardware cost and a calculation amount.

Since the level of the signal of which the partial frequency area is removed from the received signal is measured and an AGC is performed in accordance with the measured signal level, signals having various levels including the low-level signal can be detected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a configuration of an apparatus for wideband spectrum sensing according to an exemplary embodiment of the present invention.

FIG. 2 illustrates a spectrum of a sampling signal acquired from a modulated wideband converter (MWC).

FIG. 3 illustrates a flowchart of a method for wideband spectrum sensing using compressive sensing according to an exemplary embodiment of the present invention.

FIG. 4 illustrates a flowchart of a method for wideband spectrum sensing using compressive sensing according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

First, a compressive sensing technology will be simply introduced in order to help understanding the present invention.

An information communication system up to now is a digital system designed based on a sampling theory by Shannon and Nyquist. Herein, the sampling theory is based on a principle that a sampling frequency is in proportion to the expressible amount of information and only when the sampling frequency is sampled to twice or more a highest frequency of a signal, the signal may be accurately restored again. However, in the compressive sensing technology, when a predetermined condition is satisfied, the signal may be restored even though the signal is sampled at sampling rate lower than Nyquist sampling rate. The compressive sensing is the technology that, when a predetermined signal is converted into a specific domain, if a predetermined signal has a sparse feature in which most values are 0 when the signal is converted into a specific domain, may almost perfectly restore an original signal even though the sampling frequency is sampled to a sampling frequency at a sampling rate lower than the Nyquist sampling rate through a process of linear measurement. Accordingly, hardware cost and a hardware size may be reduced by the compressive sensing technology.

The compressive sensing may be divided into a linear measurement process and a signal restoration process. The linear measurement process as a signal acquiring process is a process of acquiring a signal y by transforming an original signal x through a projection process using a predetermined matrix A. Herein, x is a [1×N] matrix, y is a [1×M] matrix, and A is a [M×N] matrix, and M<N. This is expressed below as an equation.

y=Ax [Equation 1]

The signal restoration process is a process of finding the original signal x from y. It is demonstrated that x may be perfectly restored by using an L1-norm minimization problem if a condition of N>M>2K is satisfied when the number of values, which are not 0 in the original signal, is defined as sparsity and the sparsity is expressed as K.

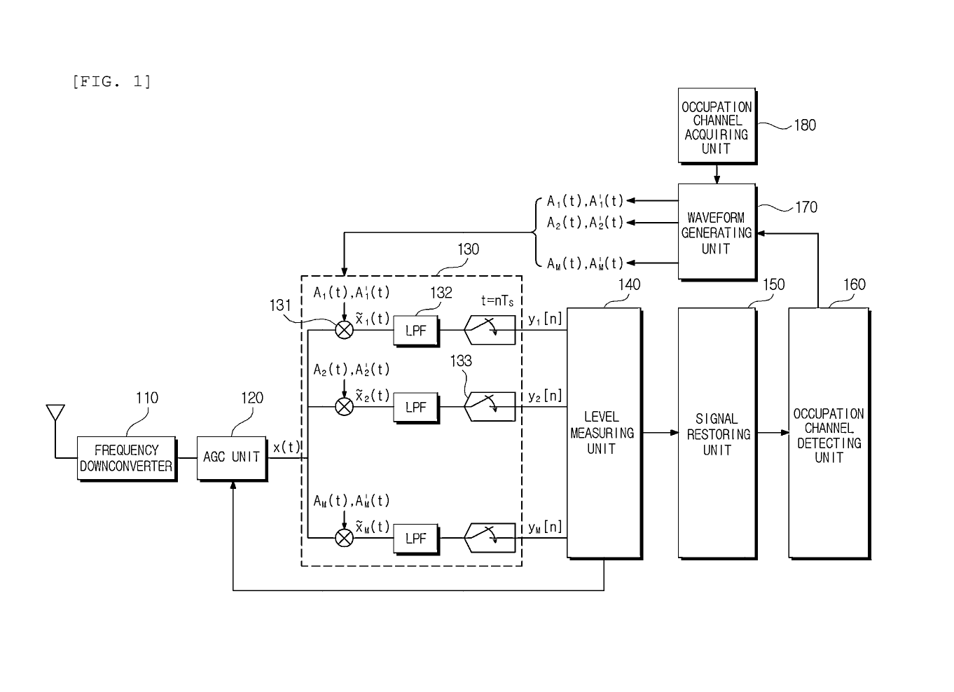

The method and apparatus for wideband spectrum sensing according to exemplary embodiments of the present invention uses a modulated wideband converter (MWC) which is one of the compressive sensing systems. FIG. 1 illustrates a configuration of an apparatus for wideband spectrum sensing according to an exemplary embodiment of the present invention.

In order to further help understanding the present invention, the modulated wideband converter (MWC) will be simply described. Referring to FIG. 1, an MWC 130 is constituted by M sampling channels, that is, constituted by M multipliers 131, M low bandpass filters 132, and M ADCs 133. A signal x(t) is simultaneously input into M channels. In an i (1≦i≦M)-th channel, x(t) is multiplied by a periodic mixing signal Aᵢ(t) having a period of Tₚ. The mixed signal passes through the low bandpass filter 132 having a bandwidth more than a sampling frequency of the ADC 133 and the filtered signal is sampled at sampling rate of fₛ=1/Tₛ. The sampling rate of each channel is much lower than that of a Nyquist sampling frequency of a wideband signal, and as a result, not an ADC having a high specification generally required in wideband spectrum sensing but an existing commercial ADC is used.

In the i-th channel, since the mixing signal Aᵢ(t) has the period of Tₚ, the mixing signal Aᵢ(t) is expressed below by Fourier expansion.

$${A}_{i} ( t ) = {\sum }_{l = - ∞}^{∞} {c}_{il} {e}^{j \frac{2 π}{{T}_{P}} lt} \qquad [ Equation 2 ]$$

Herein, cᵢ₁ represents a Fourier coefficient of Aᵢ(t).

Fourier transformation of \tilde{x}ᵢ(t)=x(t)Aᵢ(t), which is a result of multiplying x(t) and the mixing signal Aᵢ(t) by each other, is calculated below.

$$\begin{matrix}{\tilde{X}}_{i} ( f ) = {\int }_{- ∞}^{∞} {\tilde{x}}_{i} ( t ) {e}^{- j 2 π f t} d t \\ = {\int }_{- ∞}^{∞} x ( t ) ( {\sum }_{i = - ∞}^{∞} {c}_{il} {e}^{j \frac{2 π}{{T}_{P}} lt} ) {e}^{- j 2 π f t} d t \\ = {\sum }_{i = - ∞}^{∞} {c}_{il} {\int }_{- ∞}^{∞} x ( t ) {e}^{- j 2 π ( f - \frac{1}{{T}_{P}} ) t} d t \\ = {\sum }_{i = - ∞}^{∞} {c}_{il} X ( f - {lf}_{P} )\end{matrix} \qquad [ Equation 3 ]$$

Therefore, an input into the low bandpass filter 132 may be a linear combination of copies in which X(f) is shifted by the unit of fₚ from the viewpoint of a frequency domain. Discrete-time Fourier transformation (DTFT) of a sampling signal yᵢ[n] output from the ADC of the i-th channel is expressed below.

$$\begin{matrix}{Y}_{i} ( {e}^{j 2 π {fT}_{s}} ) = {\sum }_{n = - ∞}^{∞} {y}_{i} [ n ] {e}^{- j 2 π {fnT}_{s}} \\ = {\sum }_{l = - {L}_{0}}^{{L}_{0}} {c}_{il} X ( f - {lf}_{P} ) , f ∈ {F}_{s}\end{matrix} \qquad [ Equation 4 ]$$

Herein, f_{P}=1/T_{P}, Fs=[−fₛ/2, +fₛ/2], and L₀ is expressed below.

$$- \frac{{f}_{s}}{2} + ( {L}_{0} + 1 ) {f}_{P} \geq \frac{{f}_{NYQ}}{2} -> {L}_{0} = ⌈ \frac{{f}_{NYQ} + {f}_{s}}{2 {f}_{P}} ⌉ - 1$$

Herein, f_{NYQ} is the Nyquist rate of x(t).

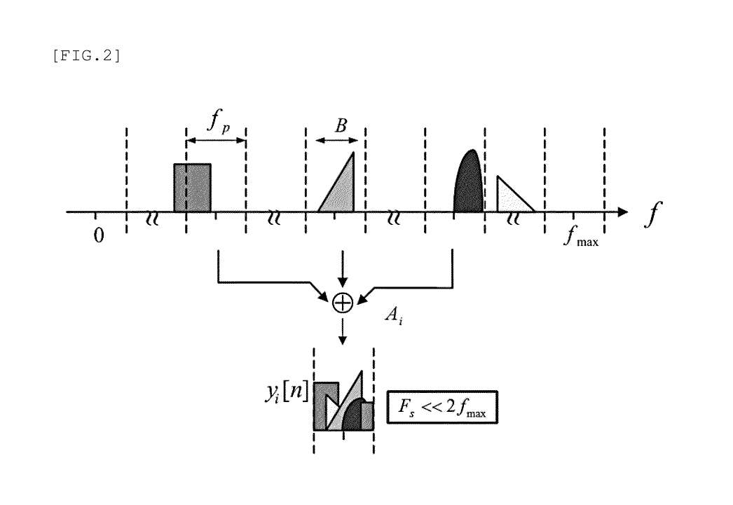

Therefore, a spectrum of yᵢ[n] may be expressed as illustrated in FIG. 2. That is, the spectrum yᵢ[n] is configured by energies in which spectrum pieces having a continuous fp length of x(t) shift to overlap with each other. Different linear combinations are formed for each channel i.

Now, referring to FIG. 1, an apparatus for wideband spectrum sensing according to an exemplary embodiment of the present invention will be described.

The apparatus for wideband spectrum sensing according to the exemplary embodiment includes a frequency downconverter 110, an AGC unit 120, an MWC 130, a level measuring unit 140, a signal restoring unit 150, an occupation channel detecting unit 160, a waveform generating unit 170, and an occupation channel acquiring unit 180.

The frequency downconverter 110 downconverts a signal received through an antenna into a frequency to output a baseband signal.

The AGC unit 120 performs an auto gain control (AGC) of the received signal from the frequency downconverter 110 in accordance with the level of the received signal or a signal level measured by the level measuring unit 140 to be described below. Herein, the AGC may be performed so that the signal level of x(t) matches a dynamic range of the ADCs 133. The AGC unit 120 may perform the AGC in accordance with a feedback of the level measuring unit 140.

The MWC 130 multiplies the mixing signal by the received signal x(t) from the AGC unit 120 through M sampling channels and acquires the sampling signal therefrom.

The level measuring unit 140 measures the level of the sampling signal of the MWC 130.

The signal restoring unit 150 acquires a restoration signal corresponding to the received signal from the sampling signal of the MWC 130 by using a compressive sensing restoration algorithm. As the compressive sensing restoration algorithm, a known algorithm such as the aforementioned L1-norm minimization problem, or the like is used.

The occupation channel detecting unit 160 detects an occupation channel of the received signal from the restoration signal of the signal restoring unit 150. The occupation channel detecting unit 160 acquires a spectrum of the restoration signal through, for example, fast Fourier transform (FET) and acquires a frequency area in which a spectrum value is more than a predetermined reference value to detect the corresponding frequency area as an occupation channel.

The waveform generating unit 170 generates the mixing signal which the MWC 130 multiplies by the received signal, and provides the generated mixing signal to the MWC 130.

In the case where there is a database having occupation channel information, the occupation channel acquiring unit 180 acquires the occupation channel information of the received signal from the database.

In the exemplary embodiment of the present invention, the AGC unit 120, the MWC 130, the level measuring unit 140, the signal restoring unit 150, the occupation channel detecting unit 160, and the waveform generating unit 170 recursively and repeatedly operate.

In the exemplary embodiment of the present invention, in the case where there is no database having the occupation channel information, the MWC 130 first multiplies the mixing signal having the periodic waveform by the received signal similarly to the aforementioned operation of the MWC 130. That is, the waveform generating unit 170 first provides the mixing signals having the periodic waveform, A₁(t), A₂(t), . . . , A_{M}(t), to the MWC 130.

However, from the second repetition, the mixing signal multiplied by the received signal, as a signal to which the mixing signal having the periodic waveform is transformed, becomes a transformed mixing signal to remove the frequency area of the occupation channel detected by the occupation channel detecting unit 160 from the received signal through the MWC 130. To this end, the waveform generating unit 170 may generate the transformed mixing signal by removing a frequency component corresponding to the frequency area of the occupation channel from the mixing signal having the periodic waveform based on an occupation channel detection result of the occupation channel detecting unit 160, and provide the generated mixing signal to the MWC 130. As such, a frequency component corresponding to a specific frequency area may be removed from the mixing signal having the periodic waveform, for example, by changing Fourier coefficients corresponding to a specific frequency area from the mixing signal having the periodic waveform. In more detail, the removal may be achieved by making the corresponding Fourier coefficient values 0 or relatively very small values. That is, since the mixing signal Aᵢ(t) having the periodic waveform makes signals of all channels overlap with each other, signals of channels from which the occupation channel is excluded among all of the channels overlap with each other by transforming Aᵢ(t) as described above. The transformed mixing signal A′ᵢ(t) may be expressed below.

$${A}_{t}^{′} ( t ) = {\sum }_{l = - ∞}^{∞} {c}_{il} {e}^{j \frac{ 2 π}{{T}_{P}} lt} - {\sum }_{l ∈ ch \_ Occupied} {c}_{il} {e}^{j \frac{2 π}{{T}_{P}} lt} \qquad [ Equation 5 ]$$

Herein, ch_Occupied represents the frequency area of the occupation channel, and as a result, lεch_Occupied represents an index which belongs to the frequency area of the occupation channel. Therefore, cᵢ₁(lεch_Occupied) means Fourier coefficients corresponding to the frequency area of the occupation channel among Fourier coefficients of

$${A}_{i} ( t ) = {\sum }_{l = - ∞}^{∞} {c}_{il} {e}^{j \frac{2 π}{{T}_{p}} lt} .$$

When the MWC 130 multiplies A′ᵢ(t) by x(t) instead of Aᵢ(t), the signal corresponding to the occupation channel is removed from the signals of all of the channels which overlap with each other, and as a result, the MWC 130 performs compressive sensing of only signals of channels other than the detected occupation channel.

As such, the frequency component corresponding to the frequency area of the occupation channel is removed from the original mixing signal having the periodic waveform, and as a result, the sampling signal of the MWC 130 becomes a signal acquired by removing the frequency area of the occupation channel from the received signal. The level measuring unit 140 measures a signal level of the signal acquired by removing the frequency area of the occupation channel and feeds back the measured signal level to the AGG unit 120. Then, the AGC unit 120 performs AGC in accordance with the signal level of the signal acquired by removing the frequency area of the occupation channel.

Signals having various magnitudes may exist because a wideband signal has a wide band and in this case, when the AGC is performed based on a high-level signal, it is difficult to detect a low-level signal. Therefore, as described above, in the related art, with respect to a channel judged not to have the signal as a sensing result after the AGC is performed based on the high-level signal, sensing is reperformed in a narrow-band unit in order to discriminate whether the signal does not actually exist or the low-level signal is not detected due to the AGC based on the high-level signal. As a result, a narrowband receiver is additionally required in addition to a wideband receiver.

However, according to the exemplary embodiment, a process is repeated, in which the AGC is performed based on the high-level signal, the frequency area of the occupation channel is removed through transformation of the mixing signal multiplied at the time of applying the MWC after detecting the occupation channel, and when the signal of which the occupation channel is received, the AGC is performed in accordance with the level of the received signal. Therefore, since the AGC is performed based on a low-level signal or a noise level which could not be detected in a first step or a previous step, the low-level signal, which could not be detected, may also be detected. That is, the exemplary embodiment is a stepwise AGC technique that first performs the AGC in accordance with the relatively high signal level, detects the occupation channel, and thereafter, removes a signal of the already detected channel in a subsequent received signal to perform the AGC in accordance with the high-level signal among remaining signals which could not be detected through the previous AGC.

In another exemplary embodiment of the present invention, in the case where the database having the occupation channel information is provided, the MWC 130 does not multiply the mixing signal having the periodic waveform by the received signal at the first but multiplies the transformed mixing signal to remove the frequency area depending on the occupation channel information from the received signal through the MWC 130, as the signal acquired by transforming the mixing signal having the periodic waveform from the first. To this end, the waveform generating unit 170 may generate the transformed mixing signal by removing a frequency component corresponding to the frequency area of the occupation channel acquired from the database from the mixing signal having the periodic waveform based on an occupation channel information acquisition result of the occupation channel acquiring unit 180, and provide the generated mixing signal to the MWC 130. Similarly as described above, a frequency component corresponding to a specific frequency area may be removed from the mixing signal having the periodic waveform by changing Fourier coefficients corresponding to the specific frequency area in the mixing signal having the periodic waveform, for example, changing the corresponding Fourier coefficient values 0 or relatively very small values. The transformed mixing signal A′ᵢ(t) may be expressed below.

$${A}_{i}^{′} ( t ) = {\sum }_{l = - ∞}^{∞} {c}_{il} {e}^{j \frac{2 π}{{T}_{P}} lt} - {\sum }_{l ∈ ch \_ DB} {c}_{il} {e}^{j \frac{2 π}{{T}_{P}} lt} \qquad [ Equation 6 ]$$

Herein, ch_DB represents the frequency area of the occupation channel information acquired from the database, and as a result, lεch_DB represents an index which belongs to the frequency area of the occupation channel information acquired from the database. Therefore, cᵢ₁(lεch_DB) means Fourier coefficients corresponding to the frequency area of the occupation channel acquired from the database among Fourier coefficients of

$${A}_{i} ( t ) = {\sum }_{l = - ∞}^{∞} {c}_{il} {e}^{j \frac{ 2 π}{{T}_{P}} lt} .$$

As such, in the case where information on an occupation channel registered in advance in the database is known, the calculation amount may be reduced by transforming the mixing signal. In other words, the signal corresponding to the occupation channel acquired from the database is excluded from the received signal through advance processing before execution by the ADC 133 by using the occupation channel information of the database. If the number of occupation channels acquired from the database is set as K′ and sparsity of the received signal is set as K, sparsity of a signal actually processed in the MWC 130 is decreased to (K−K′), and as a result, the calculation amount is decreased at a rate of (K−K′)/K as compared with a case in which advance information of the database is not provided.

That is, when the MWC 130 multiplies A′ᵢ(t) by x(t) instead of Aᵢ(t), the signal corresponding to the occupation channel acquired from the database is removed from the signals of all of the channels which overlap with each other, and as a result, the MWC 130 performs compressive sensing of only signals of channels other than the occupation channel acquired from the database. Consequently, the number of the received channels is decreased from 2K to 2(K−K′) to decrease a total calculation amount as compared with the case in which the advance information of the database is not used.

In the existing wideband spectrum sensing technique, even in the case where the occupation channel information registered in advance may be acquired from the database, the wideband signal needs to be received and processed regardless thereof. However, according to the exemplary embodiment of the present invention, since the signal is processed by excluding the occupation channel acquired from the database in the MWC 130 through transformation of the mixing signal, the number of samples is decreased and the calculation amount is decreased during the signal restoration and the detection of the occupation channel.

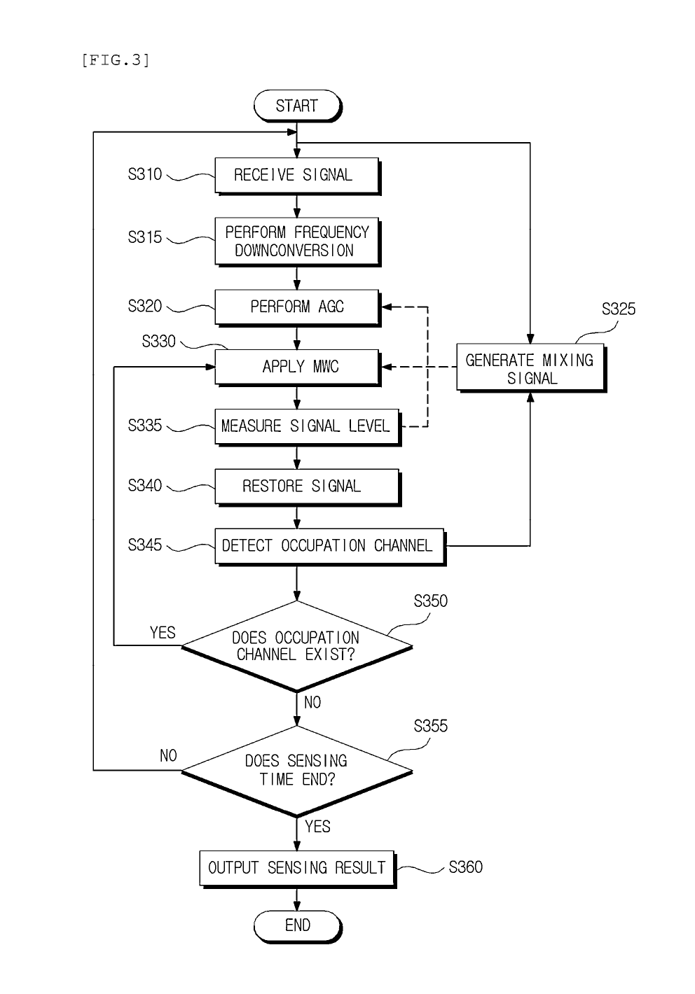

FIG. 3 is a flowchart of a method for wideband spectrum sensing using compressive sensing according to an exemplary embodiment of the present invention and is an exemplary embodiment in the case where there is no database having occupation channel information. The method for wideband spectrum sensing according to the exemplary embodiment includes steps performed in the aforementioned apparatus for wideband spectrum sensing. Therefore, a description which is duplicated with the aforementioned description will be omitted.

In step S310, the wideband spectrum sensing apparatus receives a signal through an antenna.

In step S315, a frequency downconverter 110 frequency-downconverts the received signal to a baseband.

In step S320, an AGC unit 120 performs an auto gain control (AGC) of the received signal. The AGC is continuously and repeatedly performed. The AGC is performed in accordance with the level of the received signal at the first and thereafter, the AGC is performed in accordance with a signal level measured in step S335 to be described below after applying an MWC.

Meanwhile, in step S325, a waveform generating unit 170 generates a mixing signal which the MWC 130 multiplies by the received signal. Step S325 is repeatedly performed and a mixing signal having a periodic waveform is first generated. However, the mixing signal having the periodic waveform is not generated through step S325 but may be provided in advance.

In step S330, the MWC 130 multiplies the mixing signal from step S325 by the received signal and acquires a sampling signal therefrom. Step S330 is also repeatedly performed, and as a result, the mixing signal having the periodic waveform is first used.

In step S335, a level measuring unit 140 measures the level of the acquired sampling signal. The signal level measured herein is provided to the AGC of step S320 which is repeated.

In step S340, a signal restoring unit 150 acquires a restoration signal corresponding to the received signal from the sampling signal by using a compressive sensing restoration algorithm.

In step S345, an occupation channel detecting unit 160 detects an occupation channel of the received signal from the restoration signal. In this case, the occupation channel detecting unit 160 acquires a spectrum of the restoration signal through fast Fourier transform (FET) and acquires a frequency area in which a spectrum value is more than a predetermined reference value to detect the corresponding frequency area as an occupation channel. Herein, the detected occupation channel is provided to step S325 which is repeated. When the occupation channel is detected in step S345, the process proceeds to step S330 again.

When the occupation channel is detected in step S345, a transformed mixing signal to remove the frequency area of the occupation channel detected in the received signal through the MWC 130 is generated by transforming the previously generated mixing signal, in step S325. As described above, the transformed mixing signal may be acquired by removing a frequency component corresponding to the frequency area of the occupation channel from the previously generated mixing signal, for example, by changing corresponding Fourier coefficient values 0 or relatively very small values.

The mixing signal transformed as above is provided to step S330 which is repeated, and as a result, the transformed mixing signal is multiplied by the received signal subjected to the AGC and the sampling signal is acquired therefrom, in step S330 which is repeated.

The sampling signal acquired through step S330 which is repeated corresponds to the signal acquired by removing the frequency area of the occupation channel from the received signal. In step S335 which is repeated, a signal level of the signal in which the frequency area of the occupation channel is removed is measured and the measured level is fed back to step S320. Therefore, in step S320, the AGC is performed in accordance with the signal level of the signal in which the frequency area of the occupation channel is removed.

As such, since the AGC is performed in accordance with the signal level of the signal in which the frequency area of the already detected occupation channel is removed, the signal may be restored and the occupation channel may be detected even with respect to a signal at a comparatively low reception level in a frequency area other than the already detected occupation channel in steps S340 and S345 which are repeated.

When the occupation channel is not detected in step S345, for example, when a frequency area in which a spectrum value in the spectrum of the restoration signal is more than a reference value does not exist any longer, the process proceeds to step S355.

In the exemplary embodiment of the present invention, a sensing time, that is, a data capture time may be set in advance. When the sensing time does not end in step S355, the aforementioned steps are repeatedly performed and when the sensing time ends, the process proceeds to step S360.

In step S260, the wideband spectrum sensing apparatus outputs a sensing result, that is, information on the occupation channel verified through the aforementioned steps.

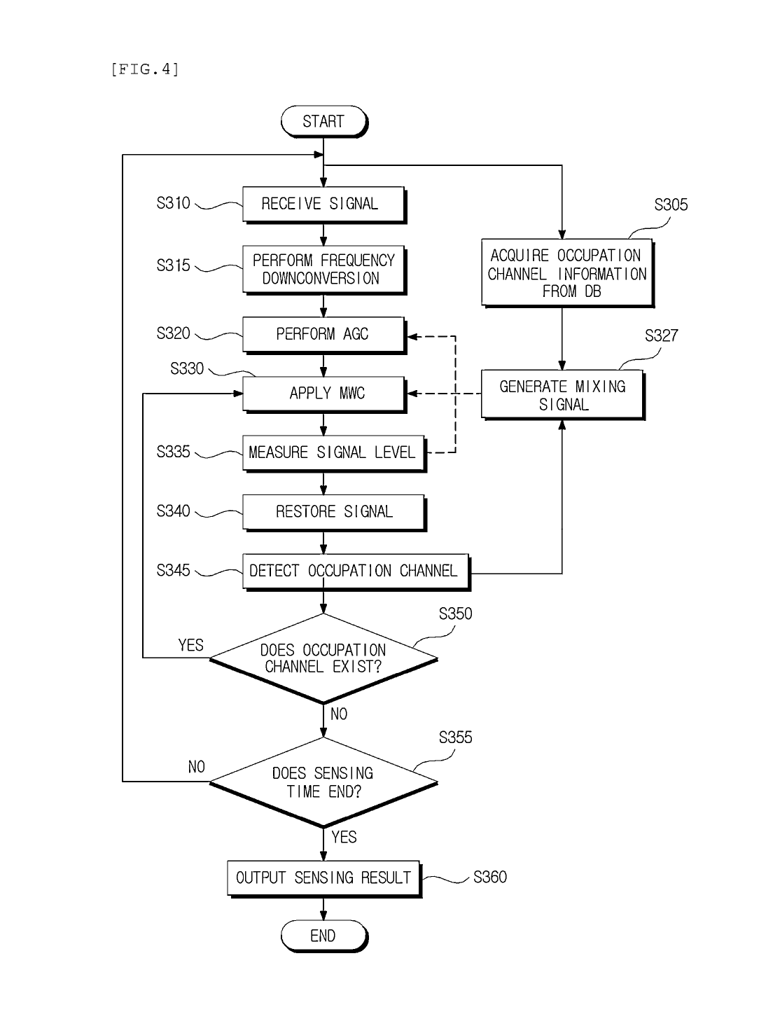

FIG. 4 is a flowchart of a method for wideband spectrum sensing using compressive sensing according to another exemplary embodiment of the present invention and is an exemplary embodiment in the case where there is provided a database having occupation channel information. The method for wideband spectrum sensing according to the exemplary embodiment also includes steps performed in the aforementioned apparatus for wideband spectrum sensing. Therefore, a description which is duplicated with the aforementioned description will be omitted. Since the exemplary embodiment is acquired by partially modifying the exemplary embodiment described with reference to FIG. 3, a difference from the exemplary embodiment described with reference to FIG. 3 will be primarily described.

In the exemplary embodiment described with reference to FIG. 3, the mixing signal having the periodic waveform is multiplied by the received signal to acquire the sampling signal therefrom, in first step S330.

However, in the exemplary embodiment, since the database having the occupation channel information is provided, the occupation channel acquiring unit 180 acquires the occupation channel information from the database in step S305. In first step S327, a transformed mixing signal to remove the frequency area of the occupation channel acquired from the database from the received signal through the MWC 130 is generated by transforming a mixing signal having a periodic waveform, which is previously provided or generated, and the transformed mixing signal is provided to first step S330. As described above, the transformed mixing signal may be acquired by removing a frequency component corresponding to the frequency area of the occupation channel from the mixing signal having the periodic waveform, for example, by changing corresponding Fourier coefficient values 0 or relatively very small values. In subsequent step S327, the mixing signal transformed based on the detected occupation channel is generated from the previously generated mixing signal, similarly to step S325 which is repeated in FIG. 3.

Therefore, in first step S330, the MWC 130 multiplies the mixing signal in which the frequency area of the occupation channel acquired from the database is removed from the mixing signal having the periodic waveform, by the received signal and acquires the sampling signal therefrom. In subsequent step S330, the mixing signal in which the frequency area of the occupation channel detected through step S345 is removed from the previously acquired mixing signal is used.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for wideband spectrum sensing using compressive sensing, the method comprising:
acquiring a sampling signal by applying a modulated wideband converter (MWC) to a received signal; and
acquiring a restoration signal corresponding to the received signal by using a compressive sensing restoration algorithm from the sampling signal,
wherein a mixing signal multiplied by the received signal at the time of applying the MWC is a signal transformed from a first mixing signal having a periodic waveform and includes a second mixing signal to remove a partial frequency area from the received signal through the application of the MWC.

2. The method of claim 1, wherein the second mixing signal is acquired by removing a frequency component corresponding to the partial frequency area from the first mixing signal.

3. The method of claim 1, wherein the acquiring of the sampling signal and the acquiring of the restoration signal are repeatedly performed.

4. The method of claim 3, further comprising:
measuring the level of the sampling signal; and
performing an auto gain control (AGC) of the received signal in accordance with the level measurement result.

5. The method of claim 3, further comprising:
detecting an occupation channel of the received signal from the restoration signal; and
generating the second mixing signal to remove the frequency area of the detected occupation channel from the received signal through the application of the MWC, from the first mixing signal.

6. The method of claim 5, wherein the generating of the second mixing signal is achieved by changing Fourier coefficients corresponding to the frequency area of the detected occupation channel in the first mixing signal.

7. The method of claim 1, further comprising:
acquiring occupation channel information of the received signal from a database; and
generating the second mixing signal to remove a frequency area of the acquired occupation channel information from the received signal through the application of the MWC, from the first mixing signal.

8. The method of claim 7, wherein the generating of the second mixing signal is achieved by changing Fourier coefficients corresponding to the frequency area of the acquired occupation channel information in the first mixing signal.

9. An apparatus for wideband spectrum sensing using compressive sensing, the apparatus comprising:
a modulated wideband converter (MWC) multiplying a mixing signal by a received signal and acquiring a sampling signal therefrom; and
a signal restoring unit acquiring a restoration signal corresponding to the received signal by using a compressive sensing restoration algorithm from the sampling signal,
wherein the mixing signal is a signal transformed from a first mixing signal having a periodic waveform and includes a second mixing signal to remove a partial frequency area from the received signal through the MWC.

10. The apparatus of claim 9, wherein the second mixing signal is acquired by removing a frequency component corresponding to the partial frequency area from the first mixing signal.

11. The apparatus of claim 9, wherein the MWC and the signal restoring unit repeatedly acquires the sampling signal and the restoration signal, respectively.

12. The apparatus of claim 11, further comprising:
a level measuring unit measuring the level of the sampling signal; and
an AGC unit performing an auto gain control (AGC) of the received signal in accordance with the level measurement result.

13. The apparatus of claim 11, further comprising:
an occupation channel detecting unit detecting an occupation channel of the received signal from the restoration signal; and
a waveform generating unit generating the second mixing signal to remove the frequency area of the detected occupation channel from the received signal through the MWC, from the first mixing signal.

14. The apparatus of claim 13, wherein the waveform generating unit generates the second mixing signal by changing Fourier coefficients corresponding to the frequency area of the detected occupation channel in the first mixing signal.

15. The apparatus of claim 9, further comprising:
an occupation channel acquiring unit acquiring occupation channel information of the received signal from a database; and
a waveform generating unit generating the second mixing signal to remove a frequency area of the acquired occupation channel information from the received signal through the MWC, from the first mixing signal.

16. The apparatus of claim 15, wherein the waveform generating unit generates the second mixing signal by changing Fourier coefficients corresponding to the frequency area of the acquired occupation channel information in the first mixing signal.
